(19) United States
(12) Patent Application Publication
(10) Pub. No.: US 2011/0192619 A1
(43) Pub. Date: Aug. 11, 2011

(54) TRACTOR-PROPELLED CULTIVATOR HAVING FLEXIBLE WEEDER BLADE

(76) Inventor: Jerry Harris, Burbank, WA (US)

(21) Appl. No.: 13/024,316

(22) Filed: Feb. 9, 2011

Related U.S. Application Data
(60) Provisional application No. 61/337,566, filed on Feb. 9, 2010.

(51) Int. Cl. A01B 49/02

(52) U.S. Cl. 172/200

(57) ABSTRACT

A cultivator mountable to a front three-point hitch of an agricultural tractor incorporates a spring steel scraper blade for the purpose of clearing weeds around the base of tree trunks in an orchard or vines in a vineyard. Cultivator heads and the scraper blade are positioned to one side of the tractor. A pair of multi-wheel cultivator heads are casterably mounted at opposite ends of a horizontal support beam, which is secured to a fulcrum bracket at the end of a slidable shaft, extension of which is under hydraulic control of the tractor operator. The scraper blade is maintained in contact with the ground and slightly above the level of the bottom of each cultivator head. While cultivating regions around tree or vines, the scraper blade can rub up against the trunks of trees or vines without causing any significant damage to bark or sapwood.

This application has a priority date of Feb. 9, 2010, based on the filing on that date of Provisional Patent Application No. 61/337,566 by the same inventor.

### BACKGROUND OF THE INVENTION

1. Field of the Invention

This invention relates generally to plows, cultivators, and scrapers used in combination with a tractor. More particularly, it relates to a tractor-propelled cultivator having an attached scraper blade.

2. History of the Prior Art

The history of farming recounts a ongoing war against animals, insects, viruses, molds, fungi and bacteria that destroy crops and weed plants that compete with crops for moisture and nutrients. In developed countries until the last century, farm laborers toiled in fields pulling weeds one by one. Although selective herbicides and automated equipment have made the process much easier, the use of herbicides can have undesirable long-term consequences on both plants and animals, many of which are unknown until problematic symptoms occur.

One of the problems associated with weed removal in orchards and vineyards is that the trunks of trees and vines may be subjected to damage if automatic powered equipment is employed to remove weeds close to the trunks.

### SUMMARY OF THE INVENTION

The present invention provides a cultivator for having a flexible blade scraper attached thereto. The cultivator, which is designed to be propelled by an agricultural tractor, and preferably mounts to a three-point front hitch, includes a stationary square tube which mounts transversely to the longitudinal axis of a tractor via a bracket which couples to the tractor hitch. A smaller movable square shaft slides within the stationary square tube and can be extended from or retracted into the stationary square tube by means of a hydraulic cylinder, one end of which is coupled to the stationary square tube, the other end of which is coupled to near the outer end of the movable square shaft. Also rigidly secured near the outer end of the movable square shaft is a fulcrum bracket. A horizontal beam is pivotally mounted near its center to the fulcrum bracket. A cultivator head assembly is mounted to each end of the horizontal beam. Each cultivator head has multiple free-spinning tine wheels coaxially mounted on a single shaft. The cultivator head assemblies are positioned such that the wheels of each assembly can be brought into contact with the surface of the earth. Each tine wheel has a plurality of peripheral excavator tines which break up the ground as the wheel rotates. Each cultivator head assembly is mounted in a free castering (i.e., swivelable) state. A scraper blade mount is rigidly affixed to the very outer end of the slidable square shaft. A flexible spring steel scraper blade, which is bolted to the scraper blade mount, projects rearwardly and outwardly from the mount. The cultivator is designed to be propelled by a tractor around tree and vine trunks in an orchard or vineyard. The spring steel scraper blade is maintained in contact with the ground and slightly above the level of the bottom of each cultivator wheel. Thus, as the cultivator with the scraper blade attached is towed around the tree or vine, the blade will either scrape away weed foliage or uproot the weeds altogether, depending on the type of weeds and the condition of the soil. The flexible blade can rub up against the trunks of trees or vines without causing any significant damage to the bark or sapwood of the tree or vine. Thus, the invention provides a much needed safe method and apparatus for eliminating weeds around the bases of trees and vines in orchard and vineyards.

### BRIEF DESCRIPTION OF THE DRAWINGS

FIG. 1 is an isometric view, taken from a upper-left-front vantage point, of the cultivator having a flexible weeder bar in a hydraulically contracted configuration;

FIG. 2 is an isometric view, taken from a upper-left-front vantage point, of the cultivator having a flexible weeder bar in a hydraulically extended configuration;

FIG. 3 is an isometric view, taken from a upper-right-front vantage point, of the cultivator having a flexible weeder bar in a hydraulically contracted configuration;

FIG. 4 is an isometric view, taken from a upper-left-rear vantage point, of the cultivator having a flexible weeder bar in a hydraulically extended configuration;

FIG. 5 is an isometric view, taken from a upper-left-rear vantage point, of the cultivator having a flexible weeder bar in a hydraulically contracted configuration;

FIG. 6 is a top plan view of the cultivator having a flexible weeder bar in a hydraulically contracted configuration;

FIG. 7 is a top plan view of the cultivator having a flexible weeder bar in a hydraulically contracted configuration;

FIG. 8 is a bottom plan view of the cultivator having a flexible weeder bar in a hydraulically contracted configuration;

FIG. 9 is a front elevational view of the cultivator having a flexible weeder bar in a hydraulically contracted configuration;

FIG. 10 is a left-side elevational view of the cultivator having a flexible weeder bar in a hydraulically contracted configuration; and

FIG. 11 is a right-side elevational view of the cultivator having a flexible weeder bar in a hydraulically contracted configuration.

### DETAILED DISCLOSURE OF THE INVENTION

The present invention will now be described in detail with reference to the attached drawing figures of the presently preferred embodiment thereof. It should be understood that although no attempt has been made to inaccurately portray the invention, the drawings may not be to exact scale and are provided primarily to facilitate an understanding of the function and construction of the invention.

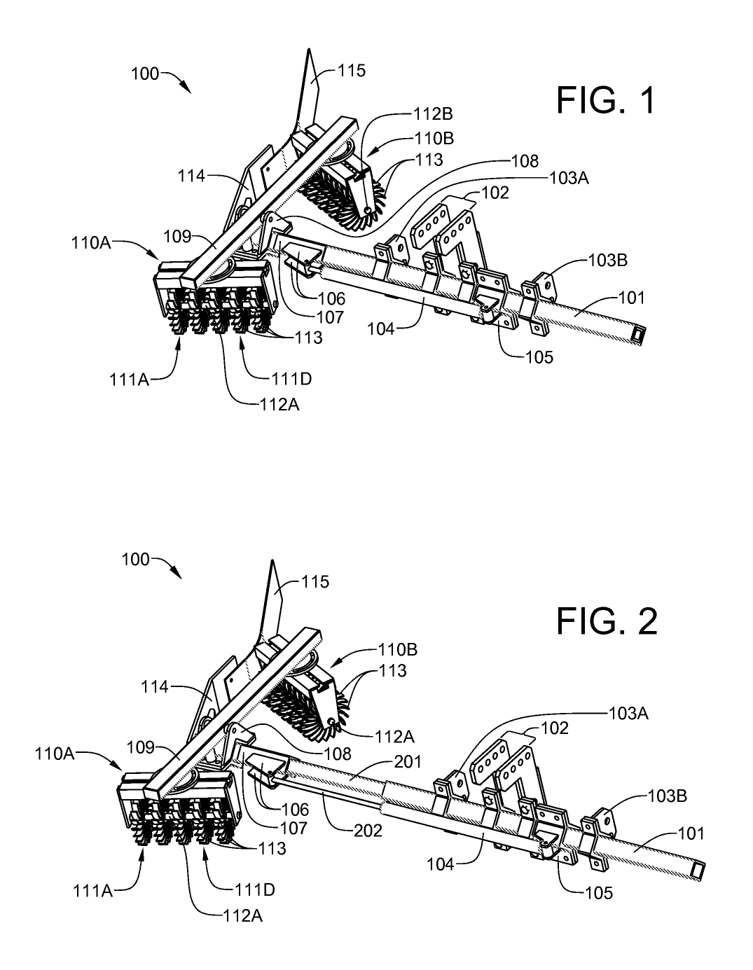

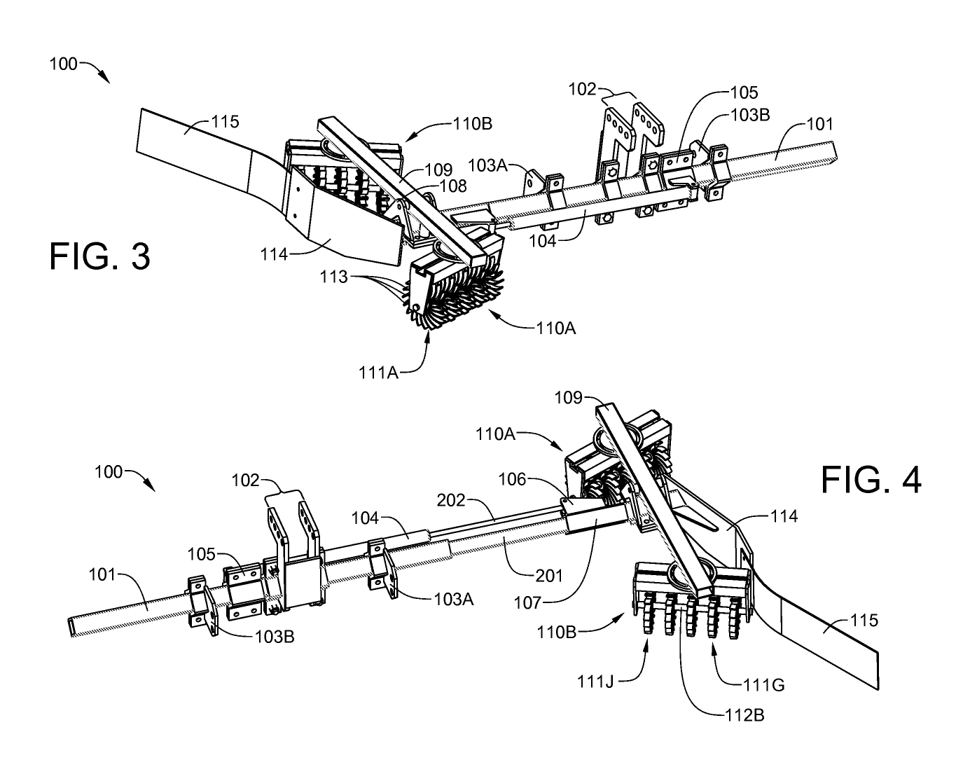

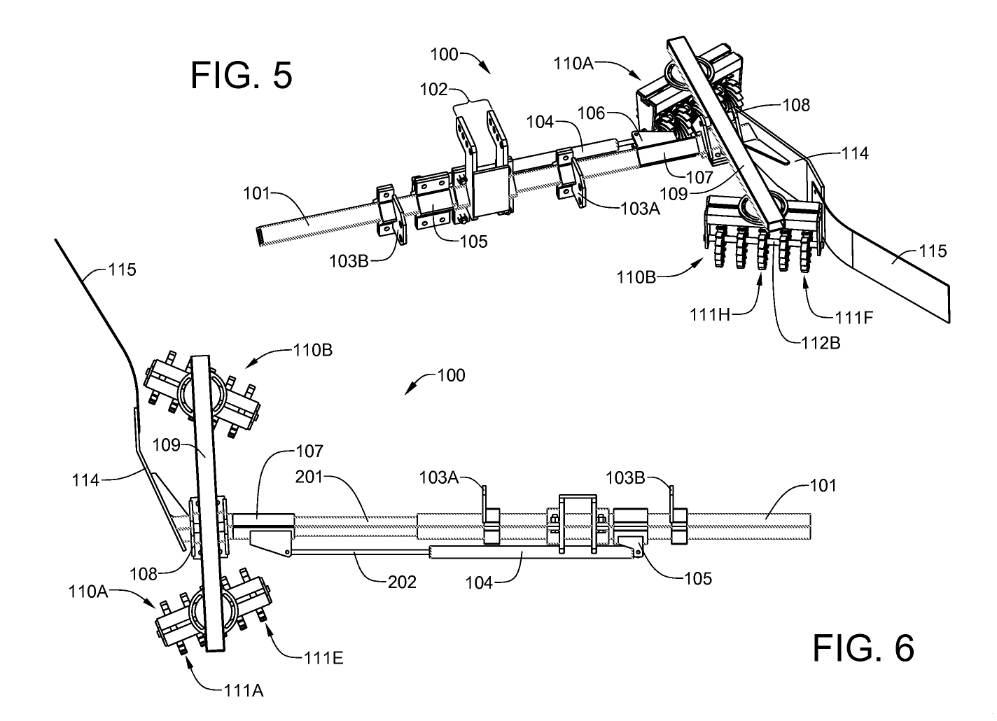

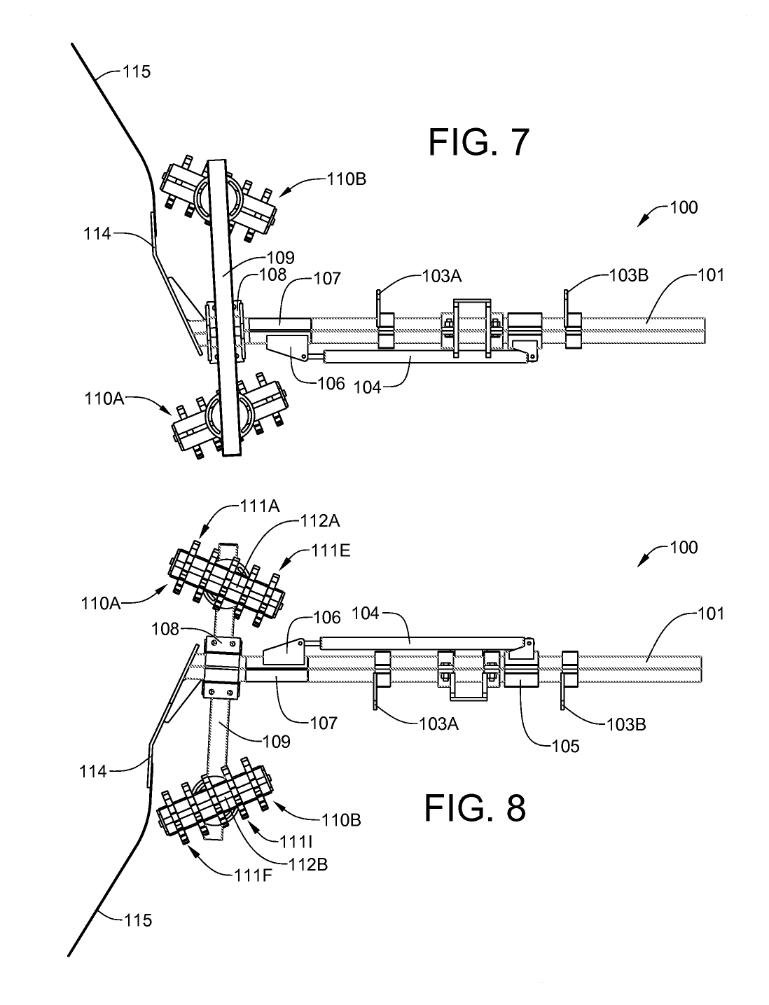

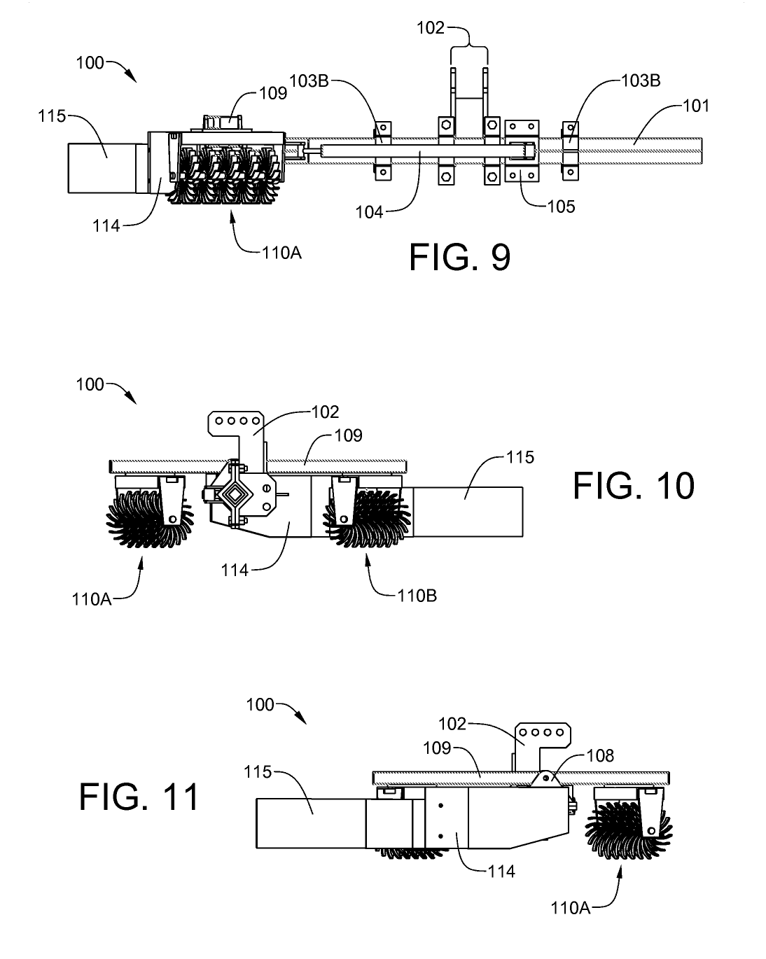

The cultivator 100 of FIGS. 1 through 11 is designed to be secured to and propelled by an agricultural tractor (not shown) via a three-point front-mounted hitch. A three-point hitch compatible with the cultivator of the present invention is disclosed in U.S. patent application Ser. No. 12/959,464 by the same inventor and titled THREE-POINT FRONT HITCH MOUNTABLE TO THE FRAME OF AN AGRICULTURAL TRACTOR.

Referring now to FIGS. 1 through 11, the cultivator 100 includes a stationary square tube 101 which mounts transversely to the longitudinal axis of a tractor via a three-point front hitch. A top mounting bracket 102 provides the upper attachment point to the hitch, while lower mounting brackets 103A and 103B provide the two lower attachment points. The top mounting bracket 102 may be coupled to the three-point hitch with a rigid link of fixed length, or with a hydraulic cylinder, the length of which can be controlled by the tractor operator (neither the rigid link nor the hydraulic cylinder for this application are shown). The square tube 101, the top mounting bracket 102, the lower mounting brackets 103A and 103B, and a first hydraulic cylinder anchoring bracket 105 that is rigidly affixed to the square tube 101, together form a hitch mounting assembly. A square shaft 201 is non-rotatably slidable within the stationary square tube 101 and can be extended from or retracted into the stationary square tube by means of a hydraulic cylinder 104, one end of which is secured to a the first anchoring bracket 105, and the other end of which is coupled to a second anchoring bracket 106 that is welded to a square tube short section 107 that fits over and is welded to the outer end of the slidable square shaft 201. Also rigidly affixed to the square tube short section 107 is a horizontal-pivot fulcrum bracket 108, to which a cultivator head support beam 109 is pivotally secured, and a scraper blade mounting bracket 114. A front cultivator head assembly 110A is mounted in a free-castering state about a generally vertical axis (i.e., freely rotatable about a generally vertical axis) to a fore end of the head support beam 109, and a rear cultivator head assembly 110B is mounted in a free-castering state to an aft end of the head support beam 109. A rearwardly and outwardly-extending weeder scraper blade 115, made preferably of resilient spring steel, is bolted to the weeder blade mounting bracket 114. For an embodiment that has been reduced to practice, each cultivator wheel assembly 110A or 110B includes five equally-spaced cultivator wheels 111A-111E and 111F-111J (111, generally), respectively, coaxially and rotatably mounted on a single shaft 112A and 112B, respectively. Each cultivator wheel 111 has a plurality of excavator tines 113, which break up the ground as the wheel 111 rotates. The cultivator is designed to be attached to a three-point hitch at the front of a tractor and pushed around tree trunks in an orchard or around vines in a vineyard. The spring steel scraper blade 115 is laterally flexible by contact with vertical objects, is maintained in contact with the ground and slightly above the level of the bottom of each cultivator wheel 108. As the free end of the spring steel scraper blade 115 contacts a vertical object projecting from the ground, the blade deflects, with the amount of deflection of the blade 115 decreasing with distance from the free end thereof. Thus, as the cultivator 100 and attached scraper blade 115 are propelled around a tree or vine, the flexible spring steel scraper blade 115 will either scrape away weed foliage or uproot the weeds altogether, depending on the type of weeds and the condition of the soil. The flexible blade can rub up against the trunks of trees or vines without causing any significant damage to the bark or sapwood of the tree. Dirt and dug-up weeds carried by the flexible scraper blade 115 provide additional protection to the tree, as the blade seldom scrapes the vine or tree directly. Consequently, the invention provides a much needed safe method and apparatus for eliminating weeds around the bases of trees in an orchard or around vines in a vineyard.

Although only several embodiments of the new container have been disclosed herein, it will be obvious to those having ordinary skill in the art that changes and modifications may be made thereto without departing from the scope and spirit of the invention as hereinafter claimed.

What is claimed is:

1. A cultivator comprising:
a hitch mounting assembly securable to a three-point hitch of an agricultural tractor;
a cultivator assembly and a resilient scraper blade coupled to a distal end of a laterally-movable shaft that is slidable and lockable within said hitch mounting assembly; and
a hydraulic cylinder coupled to both the hitch mounting assembly and the distal end of the laterally-movable shaft, said hydraulic cylinder providing bidirectional movement of the laterally-movable shaft and locking of the shaft in a desired position within a range of movement.

2. The cultivator of claim 1, wherein said cultivator assembly comprises:
a pair of cultivator heads, said cultivator heads swivelably coupled to opposite ends of a support beam, each in a free-castering state, a mid portion of said support beam being secured to a fulcrum bracket that is rigidly coupled to the distal end of said laterally-movable shaft.

3. The cultivator of claim 1, wherein each of said cultivator heads comprises a plurality of free-spinning tine wheels coaxially mounted on a single shaft.

4. The cultivator of claim 1, which further comprises a scraper blade securing bracket that is rigidly coupled to said distal end of said laterally-movable shaft.

5. The cultivator of claim 4, wherein said resilient scraper blade is bolted to said scraper blade securing bracket.

6. The cultivator of claim 1, wherein said resilient scraper blade is fabricated from spring steel.

7. The cultivator of claim 1, wherein said hydraulic cylinder and position of the laterally-movable shaft with respect to the hitch mounting assembly are controllable by an operator of the agricultural tractor.

8. A cultivator mountable to a front three-point hitch of an agricultural tractor, said cultivator comprising:
a square, hollow tube to which a plurality of adjustable brackets are clamped, said adjustable brackets providing hitch mounting points and a point of attachment for one end of a hydraulic cylinder;
a laterally-movable shaft of square cross section that is slidable and lockable within said square, hollow tube;
a cultivator assembly and a resilient scraper blade coupled generally transversely to a distal end of said laterally-movable shaft;
a hydraulic cylinder coupled to both the square, hollow tube and the distal end of the laterally-movable shaft, said hydraulic cylinder providing bidirectional movement of the laterally-movable shaft and locking of the shaft in a desired position within a range of movement.

9. The cultivator of claim 8, wherein said cultivator assembly comprises:
at least one fulcrum bracket rigidly coupled to the distal end of said laterally-movable shaft;
at least one generally horizontal support beam having a mid portion pivotally coupled to said at least one fulcrum bracket; and
a cultivator head coupled to each end of said at least one support beam in a free-castering state about a vertical axis.

10. The cultivator of claim 8, which further comprises a scraper blade securing bracket that is rigidly coupled to said distal end of said laterally-movable shaft.

11. The cultivator of claim 10, wherein said resilient scraper blade is bolted to said scraper blade securing bracket.

12. The cultivator of claim 8, wherein said resilient scraper blade is fabricated from spring steel.

13. The cultivator of claim 8, wherein said hydraulic cylinder and position of the laterally-movable shaft with respect to the hitch mounting assembly are controllable by an operator of the agricultural tractor.

14. The cultivator of claim 8, wherein resilient scraper blade is laterally flexible.

15. An implement mountable to a front three-point hitch of an agricultural tractor, said cultivator comprising:
a hitch mounting assembly securable to a three-point hitch of an agricultural tractor;
a generally horizontal shaft coupled to the hitch mounting assembly and positioned generally transverse to the direction of travel of the tractor;
a resilient spring steel scraper blade rigidly and transversely mounted to a distal end of the generally horizontal shaft, said spring steel scraper blade having a free end that laterally deflects when it contacts an object which projects vertically from the ground.

16. The implement of claim 15, which further comprises:
a cultivator assembly coupled generally transversely near the distal end of said laterally-movable shaft.

17. The implement of claim 16, wherein said cultivator assembly comprises:
at least one fulcrum bracket rigidly coupled to the distal end of said laterally-movable shaft;
at least one generally horizontal support beam having a mid portion pivotally coupled to said at least one fulcrum bracket; and
a cultivator head coupled to each end of said at least one support beam in a free-castering state about a vertical axis.

18. The implement of claim 17, wherein:
said hitch mounting assembly includes a square, hollow tube to which a plurality of adjustable brackets are clamped, said adjustable brackets providing hitch mounting points and a point of attachment for one end of a hydraulic cylinder;
said square, hollow tube slidably receives said generally horizontal shaft, which is of generally square cross section; and
said horizontal shaft is slidable and lockable within said square by means of a hydraulic cylinder that is coupled between the distal end of said horizontal shaft and said hitch mounting assembly.

19. The implement of claim 18, wherein said hydraulic cylinder is controllable by an operator of the tractor.

20. The implement of claim 17, wherein each cultivator head has multiple wheels coaxially mounted on a single axle, each wheel having multiple, radially-arrayed excavating tines.
